(19) United States
(12) Patent Application Publication
(10) Pub. No.: US 2025/0267621 A1
(43) Pub. Date: Aug. 21, 2025

(54) METHOD FOR SIDELINK BASED POSITIONING AND DEVICE THEREOF

(71) Applicant: Samsung Electronics Co., Ltd., Gyeonggi-do (KR)

(72) Inventors: Miao ZHOU, Beijing (CN); Qi XIONG, Beijing (CN); Feifei SUN, Beijing (CN)

(21) Appl. No.: 18/856,324

(22) PCT Filed: Apr. 10, 2023
(86) PCT No.: PCT/KR2023/004795

§ 371 Date: Oct. 11, 2024

(30) Foreign Application Priority Data
Apr. 12, 2022 (CN) 202210383955.4

(51) Int. Cl. H04W 64/00; H04W 4/02; H04W 72/23; H04W 72/25

(52) U.S. Cl. CPC H04W 64/003; H04W 4/025; H04W 72/23; H04W 72/25

(57) ABSTRACT

The disclosure relates to a 5G or 6G communication system for supporting a higher data transmission rate. The disclosure discloses a method performed by a first node in a communication system and a device thereof, wherein the method comprises: determining a resource for transmitting a sidelink positioning signal; and transmitting the sidelink positioning signal on the determined resources.

### TECHNICAL FIELD

The disclosure relates to the technical field of wireless communication, and in particular to a method for Sidelink (SL) communication based positioning and a device thereof in a wireless system in the fifth generation new radio access technology (5G NR) system.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIOT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultrahigh-performance communication and computing resources.

The above information is presented as background information only to assist with an understanding of the disclosure. No determination has been made, and no assertion is made, as to whether any of the above might be applicable as prior art with regard to the disclosure.

### DISCLOSURE OF INVENTION

### Technical Problem

The disclosure may provide methods and apparatuses for sidelink (SL) communication based positioning in a communication system.

### Solution to Problem

According to an embodiment of the disclosure, a method performed by a first node in a communication system is provided. The method includes: determining resources for transmitting a sidelink positioning signal; and transmitting the sidelink positioning signal on the determined resources.

According to an embodiment of the disclosure, the sidelink positioning signal includes at least one of: positioning reference signal (PRS), sounding reference signal (SRS), positioning reference signal for sidelink, and configuration signaling related to positioning.

According to an embodiment of the disclosure, the resources for transmitting the sidelink positioning signal are determined, and/or the sidelink positioning signal is transmitted when the first node satisfies at least one of the following conditions: being configured to transmit the sidelink positioning signal; an identity of a node receiving the sidelink positioning signal satisfies preset conditions; a geographical position of a node receiving the sidelink positioning signal satisfies the preset conditions; the measurement result of a specific signal and/or channel satisfies a first threshold range; the measurement result of a specific signal and/or channel is invalid; fails to detect a specific signal and/or channel; a specific pathloss satisfies the second threshold range; triggered by a higher layer to transmit the sidelink positioning signal, and/or receives a first signaling for triggering the first node to transmit the sidelink positioning signal; and obtains information of resources indicated by the higher layer or other nodes for the first node to transmit the sidelink positioning signal.

According to an embodiment of the disclosure, the specific signal and/or channel includes at least one of: a downlink synchronization signal and/or channel, a physical downlink control channel (PDCCH), a downlink shared channel (PDSCH), a sidelink synchronization signal and/or channel, a physical sidelink control channel (PSCCH), a physical sidelink shared channel (PSSCH), a physical sidelink feedback channel (PSFCH), and a positioning signal transmitted by other nodes.

According to an embodiment of the disclosure, in the case where the first signaling is received, the sidelink positioning signal is transmitted when the first node further satisfies at least one of the following conditions: the node transmitting the first signaling is a base station or a location management function (LMF); the identity of the node transmitting the first signaling satisfies the preset conditions; the geographical location indicated by the first signaling or the geographical location of the node transmitting the first signaling satisfies the preset conditions; the range of parameters corresponding to the first signaling satisfies a third threshold range and/or the range of parameters corresponding to the node transmitting the first signaling satisfies a fourth threshold range; the node transmitting the first signaling has established a connection with the first node or communicated with the first node; the node transmitting the first signaling has the capability to assist other nodes in positioning is indicated in the first signaling; the identity of the first node is indicated in the first signaling; and the condition for transmitting the sidelink positioning signal is indicated in the first signaling, and the first node satisfies the condition.

According to an embodiment of the disclosure, determining resources for transmitting the sidelink positioning signal includes: obtaining, by the first node, resources scheduled/configured by other nodes.

According to an embodiment of the disclosure, the first node obtaining resources scheduled/configured by other nodes includes obtaining, from the higher layer or other nodes, at least one of the following: information of a resource pool for transmitting the sidelink positioning signal; information of a resource set for transmitting the sidelink positioning signal; and information of resources for transmitting the sidelink positioning signal.

According to an embodiment of the disclosure, the resource pool is a node-specific resource pool or a public resource pool; and/or the resource set is a node-specific resource set or a public resource set; and/or resources are node-specific resources or public resources.

According to an embodiment of the disclosure, determining resources for transmitting the sidelink positioning signal includes at least one of: determining resources and/or the resource set for transmitting the sidelink positioning signal in the resource pool based on specific parameters and/or configurations; determining resources and/or the resource set for transmitting the sidelink positioning signal in the resource pool based on the channel monitoring result; determining resources for transmitting the sidelink positioning signal in the resource set based on specific parameters and/or configurations; and determining resources for transmitting the sidelink positioning signal in the resource set based on the channel monitoring result.

According to an embodiment of the disclosure, the method further includes: obtaining a measurement result of the sidelink positioning signal; and determining the position information of the first node and/or a second node based on the measurement result, wherein the second node is the node that measures the sidelink positioning signal.

According to an embodiment of the disclosure, the measurement result includes at least one of: PRS reference signal time difference (PRS RSTD), PRS reference signal received power (PRS RSRP), Rx-Tx time difference of user equipment (UE), relative arrival time (RTOA), SRS RSRP, Rx-Tx time difference of node, and uplink/sidelink angle measurement.

According to an embodiment of the disclosure, disclosure a method performed by a first node in a communication system is also provided, the method includes: determining resources for receiving a sidelink positioning signal; receiving the sidelink positioning signal on the determined resources; and measuring the sidelink positioning signal.

According to an embodiment of the disclosure, the sidelink positioning signal includes at least one of: positioning reference signal (PRS), sounding reference signal (SRS), positioning reference signal for sidelink, and configuration signaling related to positioning.

According to an embodiment of the disclosure, resources for receiving the sidelink positioning signal are determined, and/or the sidelink positioning signal is received and/or measured when the first node satisfies at least one of the following conditions: being configured to receive the sidelink positioning signal; an identity of a node transmitting the sidelink positioning signal satisfies preset conditions; a geographical position of a node transmitting the sidelink positioning signal satisfies the preset conditions; a measurement result of a specific signal and/or channel satisfies the first threshold range; a measurement result of a specific signal and/or channel is invalid; fails to detect a specific signal and/or channel; a specific pathloss satisfies the second threshold range; triggered by a higher layer to receive the sidelink positioning signal, and/or receives a first signaling for triggering the first node to receive the sidelink positioning signal; and receives information of resources indicated by the higher layer or other nodes for the first node to receive the sidelink positioning signal.

According to an embodiment of the disclosure, the specific signal and/or channel includes at least one of: a downlink synchronization signal and/or channel, PDCCH, PDSCH, a sidelink synchronization signal and/or channel, PSCCH, PSSCH, PSFCH, and a positioning signal transmitted by other nodes.

According to an embodiment of the disclosure, in the case where the first node receives the first signaling for triggering the first node to receive the sidelink positioning signal, the sidelink positioning signal is received through the sidelink when the first node further satisfies at least one of the following conditions: the node transmitting the first signaling is a base station or an LMF; the identity of the node transmitting the first signaling satisfies the preset conditions; the geographical location indicated by the first signaling or the geographical location of the node transmitting the first signaling satisfies the preset conditions; the range of parameters corresponding to the first signaling satisfies a third threshold range and/or the range of parameters corresponding to the node transmitting the first signaling satisfies a fourth threshold range; the node transmitting the first signaling has established a connection with the first node or communicated with the first node; the node transmitting the first signaling has the capability to assist other nodes in positioning is indicated in the first signaling; the identity of the first node is indicated in the first signaling; and the condition for receiving the sidelink positioning signal is indicated in the first signaling, and the first node satisfies the condition.

According to an embodiment of the disclosure, determining resources for receiving the sidelink positioning signal includes: obtaining, by the first node, resources scheduled/configured by other nodes.

According to an embodiment of the disclosure, the first node obtaining resources scheduled/configured by other nodes includes obtaining, from the higher layer or other nodes, at least one of the following: information of a resource pool for receiving the sidelink positioning signal; information of a resource set for receiving the sidelink positioning signal; and information of resources for receiving the sidelink positioning signal.

According to an embodiment of the disclosure, the resource pool is a node-specific resource pool or a public resource pool; and/or the resource set is a node-specific resource set or a public resource set; and/or resources are node-specific resources or public resources.

According to an embodiment of the disclosure, determining resources for receiving the sidelink positioning signal includes at least one of: determining resources and/or the resource set for receiving the sidelink positioning signal in the resource pool based on specific parameters and/or configurations; determining resources and/or the resource set for receiving the sidelink positioning signal in the resource pool based on the channel monitoring result; determining resources for receiving the sidelink positioning signal in the resource set based on specific parameters and/or configurations; and determining resources for receiving the sidelink positioning signal in the resource set based on the channel monitoring result.

According to an embodiment of the disclosure, the sidelink positioning signal is measured to obtain at least one of PRS RSTD, PRS RSRP, UE Rx-Tx time difference, RTOA, SRS RSRP, node Rx-Tx time difference, and uplink/sidelink angle measurement.

According to an embodiment of the disclosure, the method further includes: determining the position information of the first node and/or a third node based on the measurement result, wherein the third node is the node transmitting the sidelink positioning signal.

According to an embodiment of the disclosure, the method further includes: feeding back the measurement result to other nodes, the measurement result is used to determine the position information of the first node and/or other nodes.

According to an embodiment of the disclosure, a node device is also provided, which includes a transceiver; and a processor coupled to the transceiver and configured to perform the method of any one of the above descriptions.

The above and other features, aspects, and advantages of various embodiments of the disclosure will be better understood with reference to the following description and appended claims. The drawings of the specification, which form a part of this disclosure, illustrate example embodiments of this disclosure, and together with the specification, serve to explain related principles. Details of one or more embodiments of the subject matter of the disclosure are set forth in the accompanying drawings of the specification and the following description. Other potential features, aspects, and advantages of the subject matter of the disclosure will also become clear from these descriptions, drawings, and claims.

### Advantageous Effects of Invention

The disclosure may provide methods and apparatuses for sidelink (SL) communication based positioning in a communication system.

### BRIEF DESCRIPTION OF DRAWINGS

FIG. 1 illustrates an example wireless network 100 according to an embodiment of the disclosure;

FIG. 2a illustrates an example wireless transmission and reception path according to an embodiment of the disclosure;

FIG. 2b illustrates an example wireless transmission and reception path according to an embodiment of the disclosure;

FIG. 3a illustrates an example UE according to an embodiment of the disclosure;

FIG. 3b illustrates an example gNB according to an embodiment of the disclosure;

FIG. 4A is a flowchart illustrating a method according to an embodiment of the disclosure;

FIG. 4B is a flowchart illustrating a method according to an embodiment of the disclosure;

FIG. 5 schematically illustrates a flowchart of determining resources for transmitting a sidelink positioning signal according to an embodiment of the disclosure;

FIG. 6 schematically illustrates embodiment 1 according to an embodiment of the disclosure;

FIG. 7 schematically illustrates embodiment 2 according to an embodiment of the disclosure;

FIG. 8 schematically illustrates embodiment 3 according to an embodiment of the disclosure; and

FIG. 9 schematically illustrates embodiment 4 according to an embodiment of the disclosure.

### MODE FOR THE INVENTION

The following description with reference to the drawings is provided to facilitate a comprehensive understanding of various embodiments of the disclosure defined by the claims and their equivalents. This description includes various specific details to facilitate understanding but should only be considered as exemplary. Therefore, those skilled in the art will recognize that various changes and modifications can be made to the various embodiments described herein without departing from the scope and spirit of the disclosure. In addition, for the sake of clarity and conciseness, the description of well-known functions and structures may be omitted.

Terms and expressions used in the following specification and claims are not limited to their dictionary meanings, but are only used by the inventors to enable a clear and consistent understanding of the disclosure. Therefore, it should be obvious to those skilled in the art that the following descriptions of various embodiments of the disclosure are provided only for the purpose of illustration and not for the purpose of limiting the disclosure as defined by the appended claims and their equivalents.

It should be understood that singular forms of “a”, “an” and “the” include plural referents, unless the context clearly indicates otherwise. Thus, for example, references to “component surfaces” include references to one or more such surfaces.

The term “including” or “may include” refers to the existence of the corresponding disclosed functions, operations or components that can be used in various embodiments of the disclosure, rather than limiting the existence of one or more additional functions, operations or features. In addition, the term “including” or “having” can be interpreted to indicate certain features, numbers, steps, operations, constituent elements, components or combinations thereof, but should not be interpreted to exclude the possibility of the existence of one or more other features, numbers, steps, operations, constituent elements, components or combinations thereof. The term “or” used in various embodiments of the disclosure includes any listed terms and all combinations thereof. For example, “A or B” may include A, B, or both A and B. “/” used in various embodiments of the disclosure is intended to mean “and/or”. For example, “A/B” means “A and/or B”, where “A and/or B” may include A, B, or both A and B.

Unless otherwise defined, all terms (including technical terms or scientific terms) used in this disclosure have the same meanings as understood by those skilled in the art as described in this disclosure. Common terms as defined in dictionaries are interpreted to have meanings consistent with the context in relevant technical fields, and they should not be interpreted as idealized or excessively formally, unless explicitly defined as such in this disclosure.

In order to meet the increasing demand for wireless data communication services since the deployment of 4G communication systems, efforts have been made to develop improved 5G or pre-5G communication systems. Therefore, 5G or pre-5G communication systems are also called “Beyond 4G networks” or “Post-LTE systems”.

In order to achieve a higher data rate, 5G communication systems are implemented in higher frequency (millimeter, mmWave) bands, e.g., 60 GHz bands. In order to reduce propagation loss of radio waves and increase a transmission distance, technologies such as beamforming, massive multiple-input multiple-output (MIMO), full-dimensional MIMO (FD-MIMO), array antenna, analog beamforming and large-scale antenna are discussed in 5G communication systems.

In addition, in 5G communication systems, developments of system network improvement are underway based on advanced small cell, cloud radio access network (RAN), ultra-dense network, device-to-device (D2D) communication, wireless backhaul, mobile network, cooperative communication, coordinated multi-points (CoMP), reception-end interference cancellation, etc.

In 5G systems, hybrid FSK and QAM modulation (FQAM) and sliding window superposition coding (SWSC) as advanced coding modulation (ACM), and filter bank multicarrier (FBMC), non-orthogonal multiple access (NOMA) and sparse code multiple access (SCMA) as advanced access technologies have been developed.

In the Long Term Evolution (LTE) technology, sidelink communication includes two main mechanisms, which are Device to Device (D2D) direct communication and Vehicle to everything (Vehicle to Vehicle/Infrastructure/Pedestrian/Network, V2X), among which V2X is designed on the basis of D2D technology, which is superior to D2D in data rate, delay, reliability and link capacity, and is the most representative sidelink communication technology in LTE technology.

As the evolution technology of LTE, the 5G NR system also includes the further evolution of sidelink communication. As the evolution version of LTE V2X technology, NR V2X technology is formulated in version 16, and its performance in all aspects is superior. In Release 17, the 5G NR system is expected to further extend the application scenarios of NR V2X to other wider application scenarios, such as commercial sidelink communication and Public Safety (PS) scenarios. In Release 18, 5G NR SL will further introduce the evolution corresponding to other scenarios and applications, such as SL technology in high frequency (FR2), unlicensed frequency band, and SL technology corresponding to specific applications such as positioning.

In the traditional wireless communication system, the positioning technology is implemented mainly based on UE receiving from or transmitting to the base station the signal/channel for positioning. Therefore, the positioning function of UE depends on the distribution of base stations and network coverage, which requires a high cost of network layout. For example, the positioning accuracy of UE is poor when the network layout is sparse, and it is difficult to implement the positioning function when the UE is outside the cell coverage. Therefore, the introducing a sidelink communication based positioning technology can improve the applicable scenarios of positioning technology and positioning accuracy in most scenarios effectively.

The sidelink communication based positioning technology needs to be implemented based the UE receiving from or transmitting to other UEs signal/channel for positioning, and the reception/transmission mainly occurs on the sidelink channel instead of the uplink/downlink channel in the traditional positioning technology. Therefore, it is necessary to introduce a method that enables UE to determine whether to perform and which resources to use to perform reception and transmission of sidelink signal/channel for positioning.

The disclosure provides a sidelink communication based positioning method so that the implementation of the positioning function is no longer limited to the support of global navigation satellite system (GNSS) and base station, and UE can implement more accurate and efficient positioning by means of positioning signal transmission on the sidelink channel. Wherein, because the base station/LMF completely controls and schedules the transmitting and transmission of the positioning signal on the sidelink, on the one hand, the overhead is too high and the state of the sidelink channel cannot be reflected flexibly and accurately, and on the other hand, it is difficult to support two typical sidelink positioning scenarios, part of the network coverage and outside the network coverage. Therefore, the disclosure provides a scheduling method based on the central node and also provides a method for UE to determine whether to receive/transmit the sidelink signal/channel for positioning and determine the resources on the corresponding sidelink by itself, thereby improving the sidelink based positioning method and enabling the method to cover a wider range of application scenarios.

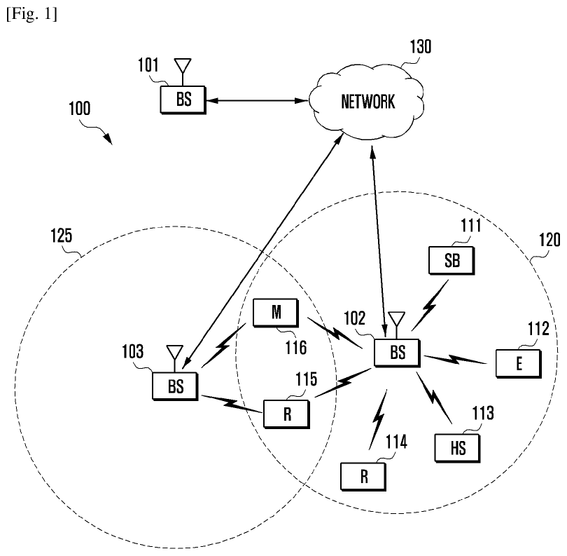

FIG. 1 illustrates an example wireless network 100 according to an embodiment of the disclosure. The embodiment of the wireless network 100 shown in FIG. 1 is for illustration only. Other embodiments of the wireless network 100 can be used without departing from the scope of the disclosure.

The wireless network 100 includes a gNodeB (gNB) 101, a gNB 102, and a gNB 103. gNB 101 communicates with gNB 102 and gNB 103. gNB 101 also communicates with at least one Internet Protocol (IP) network 130, such as the Internet, a private IP network, or other data networks.

Depending on a type of the network, other well-known terms such as “base station” or “access point” can be used instead of “gNodeB” or “gNB”. For convenience, the terms “gNodeB” and “gNB” are used in this patent document to refer to network infrastructure components that provide wireless access for remote terminals. And, depending on the type of the network, other well-known terms such as “mobile station”, “user station”, “remote terminal”, “wireless terminal” or “user apparatus” can be used instead of “user equipment” or “UE”. For convenience, the terms “user equipment” and “UE” are used in this patent document to refer to remote wireless devices that wirelessly access the gNB, no matter whether the UE is a mobile device (such as a mobile phone or a smart phone) or a fixed device (such as a desktop computer or a vending machine).

gNB 102 provides wireless broadband access to the network 130 for a first plurality of User Equipments (UEs) within a coverage area 120 of gNB 102. The first plurality of UEs include a UE 111, which may be located in a Small Business (SB); a UE 112, which may be located in an enterprise (E); a UE 113, which may be located in a WiFi Hotspot (HS); a UE 114, which may be located in a first residence (R); a UE 115, which may be located in a second residence (R); a UE 116, which may be a mobile device (M), such as a cellular phone, a wireless laptop computer, a wireless PDA, etc. GNB 103 provides wireless broadband access to network 130 for a second plurality of UEs within a coverage area 125 of gNB 103. The second plurality of UEs include a UE 115 and a UE 116. In some embodiments, one or more of gNBs 101-103 can communicate with each other and with UEs 111-116 using 5G, Long Term Evolution (LTE), LTE-A, WiMAX or other advanced wireless communication technologies.

The dashed lines show approximate ranges of the coverage areas 120 and 125, and the ranges are shown as approximate circles merely for illustration and explanation purposes. It should be clearly understood that the coverage areas associated with the gNBs, such as the coverage areas 120 and 125, may have other shapes, including irregular shapes, depending on configurations of the gNBs and changes in the radio environment associated with natural obstacles and man-made obstacles.

As will be described in more detail below, one or more of gNB 101, gNB 102, and gNB 103 include a 2D antenna array as described in embodiments of the disclosure. In some embodiments, one or more of gNB 101, gNB 102, and gNB 103 support codebook designs and structures for systems with 2D antenna arrays.

Although FIG. 1 illustrates an example of the wireless network 100, various changes can be made to FIG. 1. The wireless network 100 can include any number of gNBs and any number of UEs in any suitable arrangement, for example. Furthermore, gNB 101 can directly communicate with any number of UEs and provide wireless broadband access to the network 130 for those UEs. Similarly, each gNB 102-103 can directly communicate with the network 130 and provide direct wireless broadband access to the network 130 for the UEs. In addition, gNB 101, 102 and/or 103 can provide access to other or additional external networks, such as external telephone networks or other types of data networks.

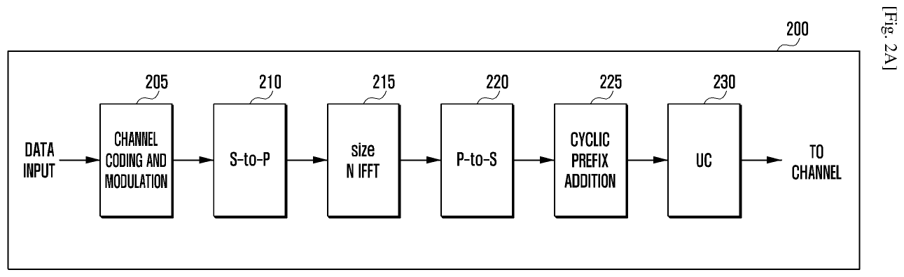

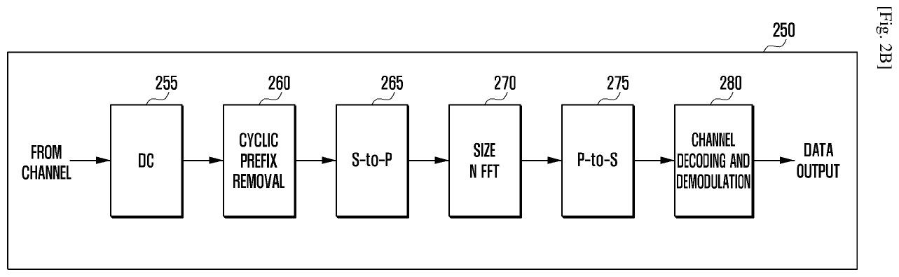

FIGS. 2a and 2b illustrate example wireless transmission and reception paths according to embodiments of the disclosure. In the following description, the transmission path 200 can be described as being implemented in a gNB, such as gNB 102, and the reception path 250 can be described as being implemented in a UE, such as UE 116. However, it should be understood that the reception path 250 can be implemented in a gNB and the transmission path 200 can be implemented in a UE. In some embodiments, the reception path 250 is configured to support codebook designs and structures for systems with 2D antenna arrays as described in embodiments of the disclosure.

The transmission path 200 includes a channel coding and modulation block 205, a Serial-to-Parallel (S-to-P) block 210, a size N Inverse Fast Fourier Transform (IFFT) block 215, a Parallel-to-Serial (P-to-S) block 220, a cyclic prefix addition block 225, and an up-converter (UC) 230. The reception path 250 includes a down-converter (DC) 255, a cyclic prefix removal block 260, a Serial-to-Parallel (S-to-P) block 265, a size N Fast Fourier Transform (FFT) block 270, a Parallel-to-Serial (P-to-S) block 275, and a channel decoding and demodulation block 280.

In the transmission path 200, the channel coding and modulation block 205 receives a set of information bits, applies coding (such as Low Density Parity Check (LDPC) coding), and modulates the input bits (such as using Quadrature Phase Shift Keying (QPSK) or Quadrature Amplitude Modulation (QAM)) to generate a sequence of frequency-domain modulated symbols. The Serial-to-Parallel (S-to-P) block 210 converts (such as demultiplexes) serial modulated symbols into parallel data to generate N parallel symbol streams, where N is a size of the IFFT/FFT used in gNB 102 and UE 116. The size N IFFT block 215 performs IFFT operations on the N parallel symbol streams to generate a time-domain output signal. The Parallel-to-Serial block 220 converts (such as multiplexes) parallel time-domain output symbols from the Size N IFFT block 215 to generate a serial time-domain signal. The cyclic prefix addition block 225 inserts a cyclic prefix into the time-domain signal. The up-converter 230 modulates (such as up-converts) the output of the cyclic prefix addition block 225 to an RF frequency for transmission via a wireless channel. The signal can also be filtered at a baseband before switching to the RF frequency.

The RF signal transmitted from gNB 102 arrives at UE 116 after passing through the wireless channel, and operations in reverse to those at gNB 102 are performed at UE 116. The down-converter 255 down-converts the received signal to a baseband frequency, and the cyclic prefix removal block 260 removes the cyclic prefix to generate a serial time-domain baseband signal. The Serial-to-Parallel block 265 converts the time-domain baseband signal into a parallel time-domain signal. The Size N FFT block 270 performs an FFT algorithm to generate N parallel frequency-domain signals. The Parallel-to-Serial block 275 converts the parallel frequency-domain signal into a sequence of modulated data symbols. The channel decoding and demodulation block 280 demodulates and decodes the modulated symbols to recover the original input data stream.

Each of gNBs 101-103 may implement a transmission path 200 similar to that for transmitting to UEs 111-116 in the downlink, and may implement a reception path 250 similar to that for receiving from UEs 111-116 in the uplink. Similarly, each of UEs 111-116 may implement a transmission path 200 for transmitting to gNBs 101-103 in the uplink, and may implement a reception path 250 for receiving from gNBs 101-103 in the downlink.

Each of the components in FIGS. 2a and 2b can be implemented using only hardware, or using a combination of hardware and software/firmware. As a specific example, at least some of the components in FIGS. 2a and 2b may be implemented in software, while other components may be implemented in configurable hardware or a combination of software and configurable hardware. For example, the FFT block 270 and IFFT block 215 may be implemented as configurable software algorithms, in which the value of the size N may be modified according to the implementation.

Furthermore, although described as using FFT and IFFT, this is only illustrative and should not be interpreted as limiting the scope of the disclosure. Other types of transforms can be used, such as Discrete Fourier transform (DFT) and Inverse Discrete Fourier Transform (IDFT) functions. It should be understood that for DFT and IDFT functions, the value of variable N may be any integer (such as 1, 2, 3, 4, etc.), while for FFT and IFFT functions, the value of variable N may be any integer which is a power of 2 (such as 1, 2, 4, 8, 16, etc.).

Although FIGS. 2a and 2b illustrate examples of wireless transmission and reception paths, various changes may be made to FIGS. 2a and 2b. For example, various components in FIGS. 2a and 2b can be combined, further subdivided or omitted, and additional components can be added according to specific requirements. Furthermore, FIGS. 2a and 2b are intended to illustrate examples of types of transmission and reception paths that can be used in a wireless network. Any other suitable architecture can be used to support wireless communication in a wireless network.

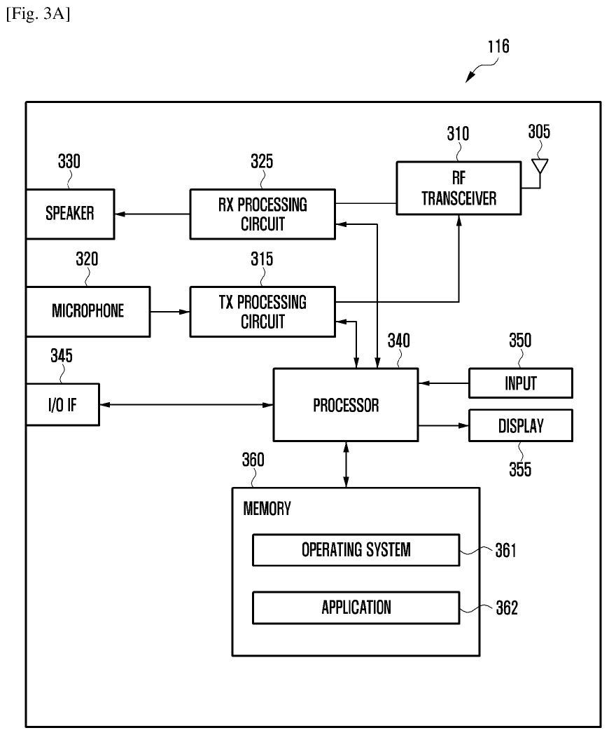

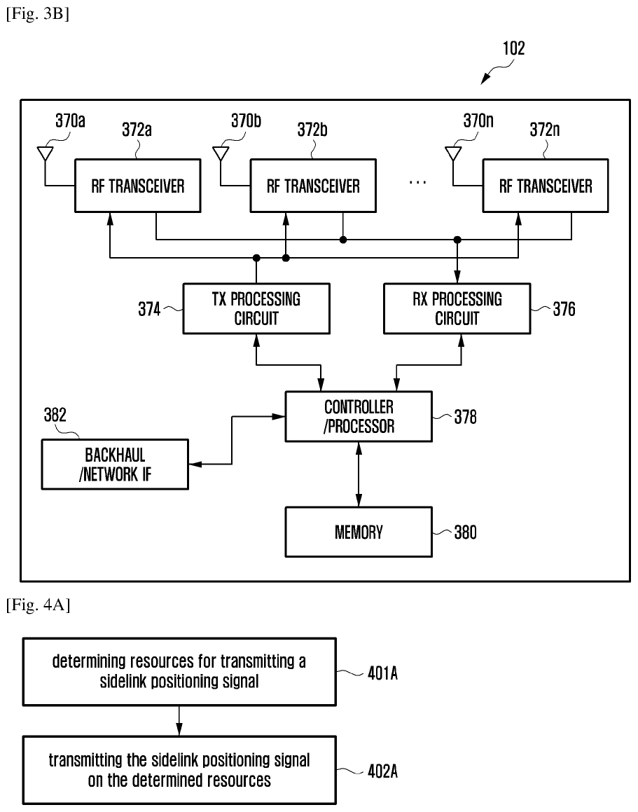

FIG. 3a illustrates an example UE 116 according to an embodiment of the disclosure. The embodiment of UE 116 shown in FIG. 3a is for illustration only, and UEs 111-115 of FIG. 1 can have the same or similar configuration. However, a UE has various configurations, and FIG. 3a does not limit the scope of the disclosure to any specific implementation of the UE.

UE 116 includes an antenna 305, a radio frequency (RF) transceiver 310, a transmission (TX) processing circuit 315, a microphone 320, and a reception (RX) processing circuit 325. UE 116 also includes a speaker 330, a processor/controller 340, an input/output (I/O) interface 345, an input device(s) 350, a display 355, and a memory 360. The memory 360 includes an operating system (OS) 361 and one or more applications 362.

The RF transceiver 310 receives an incoming RF signal transmitted by a gNB of the wireless network 100 from the antenna 305. The RF transceiver 310 down-converts the incoming RF signal to generate an intermediate frequency (IF) or baseband signal. The IF or baseband signal is transmitted to the RX processing circuit 325, where the RX processing circuit 325 generates a processed baseband signal by filtering, decoding and/or digitizing the baseband or IF signal. The RX processing circuit 325 transmits the processed baseband signal to speaker 330 (such as for voice data) or to processor/controller 340 for further processing (such as for web browsing data).

The TX processing circuit 315 receives analog or digital voice data from microphone 320 or other outgoing baseband data (such as network data, email or interactive video game data) from processor/controller 340. The TX processing circuit 315 encodes, multiplexes, and/or digitizes the outgoing baseband data to generate a processed baseband or IF signal. The RF transceiver 310 receives the outgoing processed baseband or IF signal from the TX processing circuit 315 and up-converts the baseband or IF signal into an RF signal transmitted via the antenna 305.

The processor/controller 340 can include one or more processors or other processing devices and execute an OS 361 stored in the memory 360 in order to control the overall operation of UE 116. For example, the processor/controller 340 can control the reception of forward channel signals and the transmission of backward channel signals through the RF transceiver 310, the RX processing circuit 325 and the TX processing circuit 315 according to well-known principles. In some embodiments, the processor/controller 340 includes at least one microprocessor or microcontroller.

The processor/controller 340 is also capable of executing other processes and programs residing in the memory 360, such as operations for channel quality measurement and reporting for systems with 2D antenna arrays as described in embodiments of the disclosure. The processor/controller 340 can move data into or out of the memory 360 as required by an execution process. In some embodiments, the processor/controller 340 is configured to execute the application 362 based on the OS 361 or in response to signals received from the gNB or the operator. The processor/controller 340 is also coupled to an I/O interface 345, where the I/O interface 345 provides UE 116 with the capability to connect to other devices such as laptop computers and handheld computers. I/O interface 345 is a communication path between these accessories and the processor/controller 340.

The processor/controller 340 is also coupled to the input device(s) 350 and the display 355. An operator of UE 116 can input data into UE 116 using the input device(s) 350. The display 355 may be a liquid crystal display or other display capable of presenting text and/or at least limited graphics (such as from a website). The memory 360 is coupled to the processor/controller 340. A part of the memory 360 can include a random access memory (RAM), while another part of the memory 360 can include a flash memory or other read-only memory (ROM).

Although FIG. 3a illustrates an example of UE 116, various changes can be made to FIG. 3a. For example, various components in FIG. 3a can be combined, further subdivided or omitted, and additional components can be added according to specific requirements. As a specific example, the processor/controller 340 can be divided into a plurality of processors, such as one or more central processing units (CPUs) and one or more graphics processing units (GPUs). Furthermore, although FIG. 3a illustrates that the UE 116 is configured as a mobile phone or a smart phone, UEs can be configured to operate as other types of mobile or fixed devices.

FIG. 3b illustrates an example gNB 102 according to an embodiment of the disclosure. The embodiment of gNB 102 shown in FIG. 3b is for illustration only, and other gNBs of FIG. 1 can have the same or similar configuration. However, a gNB has various configurations, and FIG. 3b does not limit the scope of the disclosure to any specific implementation of a gNB. It should be noted that gNB 101 and gNB 103 can include the same or similar structures as gNB 102.

As shown in FIG. 3b, gNB 102 includes a plurality of antennas 370a-370n, a plurality of RF transceivers 372a-372n, a transmission (TX) processing circuit 374, and a reception (RX) processing circuit 376. In certain embodiments, one or more of the plurality of antennas 370a-370n include a 2D antenna array. gNB 102 also includes a controller/processor 378, a memory 380, and a backhaul or network interface 382.

RF transceivers 372a-372n receive an incoming RF signal from antennas 370a-370n, such as a signal transmitted by UEs or other gNBs. RF transceivers 372a-372n down-convert the incoming RF signal to generate an IF or baseband signal. The IF or baseband signal is transmitted to the RX processing circuit 376, where the RX processing circuit 376 generates a processed baseband signal by filtering, decoding and/or digitizing the baseband or IF signal. RX processing circuit 376 transmits the processed baseband signal to controller/processor 378 for further processing.

The TX processing circuit 374 receives analog or digital data (such as voice data, network data, email or interactive video game data) from the controller/processor 378. TX processing circuit 374 encodes, multiplexes and/or digitizes outgoing baseband data to generate a processed baseband or IF signal. RF transceivers 372a-372n receive the outgoing processed baseband or IF signal from TX processing circuit 374 and upconvert the baseband or IF signal into an RF signal transmitted via antennas 370a-370n.

The controller/processor 378 can include one or more processors or other processing devices that control the overall operation of gNB 102. For example, the controller/processor 378 can control the reception of forward channel signals and the transmission of backward channel signals through the RF transceivers 372a-372n, the RX processing circuit 376 and the TX processing circuit 374 according to well-known principles. The controller/processor 378 can also support additional functions, such as higher-level wireless communication functions. For example, the controller/processor 378 can perform a Blind Interference Sensing (BIS) process such as that performed through a BIS algorithm, and decode a received signal from which an interference signal is subtracted. A controller/processor 378 may support any of a variety of other functions in gNB 102. In some embodiments, the controller/processor 378 includes at least one microprocessor or microcontroller.

The controller/processor 378 is also capable of executing programs and other processes residing in the memory 380, such as a basic OS. The controller/processor 378 can also support channel quality measurement and reporting for systems with 2D antenna arrays as described in embodiments of the disclosure. In some embodiments, the controller/processor 378 supports communication between entities such as web RTCs. The controller/processor 378 can move data into or out of the memory 380 as required by an execution process.

The controller/processor 378 is also coupled to the backhaul or network interface 382. The backhaul or network interface 382 allows gNB 102 to communicate with other devices or systems through a backhaul connection or through a network. The backhaul or network interface 382 can support communication over any suitable wired or wireless connection(s). For example, when gNB 102 is implemented as a part of a cellular communication system, such as a cellular communication system supporting 5G or new radio access technology or NR, LTE or LTE-A, the backhaul or network interface 382 can allow gNB 102 to communicate with other gNBs through wired or wireless backhaul connections. When gNB 102 is implemented as an access point, the backhaul or network interface 382 can allow gNB 102 to communicate with a larger network, such as the Internet, through a wired or wireless local area network or through a wired or wireless connection. The backhaul or network interface 382 includes any suitable structure that supports communication through a wired or wireless connection, such as an Ethernet or an RF transceiver.

The memory 380 is coupled to the controller/processor 378. A part of the memory 380 can include an RAM, while another part of the memory 380 can include a flash memory or other ROMs. In certain embodiments, a plurality of instructions, such as the BIS algorithm, are stored in the memory. The plurality of instructions are configured to cause the controller/processor 378 to execute the BIS process and decode the received signal after subtracting at least one interference signal determined by the BIS algorithm.

As will be described in more detail below, the transmission and reception paths of gNB 102 (implemented using RF transceivers 372a-372n, TX processing circuit 374 and/or RX processing circuit 376) support aggregated communication with FDD cells and TDD cells.

Although FIG. 3b illustrates an example of gNB 102, various changes may be made to FIG. 3b. For example, gNB 102 can include any number of each component shown in FIG. 3a. As a specific example, the access point can include many backhaul or network interfaces 382, and the controller/processor 378 can support routing functions to route data between different network addresses. As another specific example, although shown as including a single instance of the TX processing circuit 374 and a single instance of the RX processing circuit 376, gNB 102 can include multiple instances of each (such as one for each RF transceiver).

In the Long Term Evolution (LTE) technology, sidelink communication includes two main mechanisms, which are Device to Device (D2D) direct communication and Vehicle to everything (Vehicle to Vehicle/Infrastructure/Pedestrian/Network, V2X), among which V2X is designed on the basis of D2D technology, which is superior to D2D in data rate, delay, reliability and link capacity, and is the most representative sidelink communication technology in LTE technology. In 5G system, sidelink communication mainly includes vehicle to everything (V2X) communication at present.

As the evolution technology of LTE, the 5G NR system also includes the further evolution of sidelink communication. As the evolution version of LTE V2X technology, NR V2X technology is formulated in version 16, and its performance in all aspects is superior. In Release 17, the 5G NR system is expected to further extend the application scenarios of NR V2X to other wider application scenarios, such as commercial sidelink communication and Public Safety (PS) scenarios. In Release 18, the evolution of sidelink communication includes support to directions such as unlicensed frequency band, FR2, carrier aggregation, co-channel coexistence with LTE, and technologies in other fields such as positioning.

In this embodiment of the application, the information configured by the base station, indicated by signaling, configured by the higher layer and pre-configured includes a set of configuration information; also includes multiple sets of configuration information from which the UE selects a set of configuration information to use according to predefined condition; and also includes a set of configuration information containing a plurality of subsets from which the UE selects one subset to use according to predefined condition.

In the embodiment of this application, lower than a threshold can also be replaced by lower than or equal to a threshold, higher than (exceeding) a threshold can also be replaced by higher than or equal to a threshold, less than or equal to can also be replaced by less than, greater than or equal to or greater than; or vice versa.

Some technical solutions provided in the embodiment of this application are specifically described based on the V2X system, but its application scenario should not be limited to the V2X system in sidelink communication, but can also be applied to other sidelink transmission systems. For example, the design based on the V2X sub-channel in the following embodiments can also be used for the D2D sub-channel or other sub-channels of sidelink transmission. The V2X resource pool in the following embodiments can also be replaced by a D2D resource pool in other sidelink transmission systems, such as D2D.

In the embodiment of this application, when the sidelink communication system is a V2X system, the terminal or UE can be a Vehicle, an Infrastructure, a Pedestrian, and other types of terminals or UEs.

The base station in this specification can also be replaced by other nodes, such as sidelink nodes, a specific example is the roadside station (infrastructure) UE in the sidelink system. Any mechanism applicable to the base station in this embodiment can also be similarly used in the scenarios where the base station is replaced by other sidelink nodes, and the description will not be repeated.

In this specification, slots can also be replaced with time units, candidate slots can also be replaced with candidate time units, and candidate single slot resources can also be replaced with candidate single time unit resources. In a specific example, the time unit can include a specific time length, such as several consecutive symbols.

The slot in this specification can be either a subframe or slot in the physical sense, or a subframe or slot the logical sense. Specifically, the subframe or slot in the logical sense is the subframe or slot corresponding to the resource pool of sidelink communication. For example, in the V2X system, the resource pool is defined by a repeated bitmap, which is mapped to a specific set of slots, the specific set of slots can be all slots, or all other slots except some specific slots (e.g., slots for transmitting Master Information Block (MIB)/System Information Block (SIB)). The slot indicated as “1” in the bitmap can be used for V2X transmission and belongs to the slot corresponding to the V2X resource pool; the slot indicated as “0” cannot be used for V2X transmission and does not belong to the slot corresponding to the V2X resource pool.

The following is a typical application scenario to illustrate the difference between physical or logical subframes or slots: when calculating the time domain gap between two specific channels/messages (such as PSSCH carrying sidelink data and PSFCH carrying corresponding feedback information), it is assumed that the gap is N slots. If physical subframes or slots are calculated, the N slots correspond to the absolute time length of N*x milliseconds in the time domain, and x is the time length of the physical slot (subframe) under the numerology of the scenario in millisecond. Otherwise, if the logical subframes or slots are calculated, take the sidelink resource pool defined by the bitmap as an example, the gap of the N slots corresponds to the N slots indicated as “1” in the bitmap, and the absolute time length of the gap changes with the specific configuration of the sidelink communication resource pool without a fixed value.

Further, the slot in this specification can be a complete slot or several symbols corresponding to sidelink communication in one slot. For example, when the sidelink communication is configured to be performed on the X1˜X2 symbols of each slot, the slot in the following embodiment is the X1˜X2 symbols in the slot in this scenario; alternatively, when the sidelink communication is configured as mini-slot transmission, the slot in the following embodiments is mini-slot defined or configured in the sidelink system rather than the slot in the NR system; alternatively, when the sidelink communication is configured as symbol level transmission, the slots in the following embodiments can be replaced with symbols, or can be replaced with N symbols with time domain granularity as symbol level transmission. Exemplary embodiments of the disclosure are further described below with reference to the accompanying drawings.

And the text and drawings are only provided as examples to help readers understand this disclosure. They are not intended and should not be construed to limit the scope of the disclosure in any way. Although some embodiments and examples have been provided, based on the disclosure herein, it is obvious to those skilled in the art that changes can be made to the illustrated embodiments and examples without departing from the scope of this disclosure.

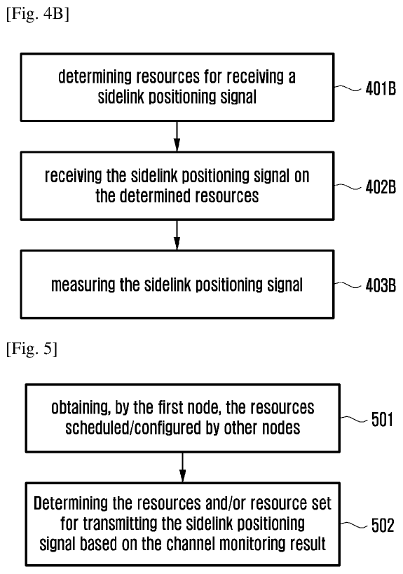

FIG. 4A is a flowchart illustrating a method according to an embodiment of the disclosure, wherein the method includes the following steps:
Step 401A: determine resources for transmitting the sidelink positioning signal.

Specifically, on the sidelink, determine resources for transmitting the sidelink positioning signal.
Step 402A: transmit the sidelink positioning signal on the determined resources.

FIG. 4B is a flowchart illustrating a method according to an embodiment of the disclosure, wherein the method includes the following steps:
Step 401B: determine the resources for receiving the sidelink positioning signal.

Specifically, on the sidelink, determine the resources for receiving the sidelink positioning signal.
Step 402B: receive the sidelink positioning signal on the determined resources. and
Step 403B: measure the sidelink positioning signal.

In an example embodiment, a method for UE to determine whether to transmit/receive positioning-related signal/channel through sidelink, and to determine corresponding sidelink resources and transmit/receive positioning-related signal/channel on the resources is provided.

The sidelink communication based positioning technology can support UE-based positioning and UE-assisted positioning. UE-based positioning mainly involves in transmitting or receiving positioning signal and collecting measurement result by the UE, and positioning at the UE based on the collected results. UE-assisted positioning mainly involves in transmitting positioning signal, or measuring the positioning signal and reporting the measurement result to the network side by the UE, and completing the positioning of the UE by the network side. Accordingly, in the sidelink communication based positioning technology, there are several typical scenarios:
the first UE transmits a signal/channel for positioning to the base station and/or other sidelink UEs through sidelink for measurement by the base station and/or other sidelink UEs; the measurement result can be reported to the network side or fed back to the first UE, and used to determine the location information of the first UE;
the first UE transmits a signal/channel for positioning to the base station and/or other sidelink UEs through sidelink for measurement by the base station and/or other sidelink UEs; the measurement result can be reported to the network side or fed back to the first UE, and used to determine the location information of other UEs;
the first UE receives a signal/channel for positioning transmitted by the base station and/or other sidelink UEs through sidelink and measures it; the measurement result can be reported to the network side or fed back to the base station and/or other sidelink UEs, and used to determine the location information of the first UE;
the first UE receives a signal/channel for positioning transmitted by the base station and/or other sidelink UEs through sidelink and measures it; the measurement result can be reported to the network side or fed back to the base station and/or other sidelink UEs, and used to determine the location information of other UEs.

In this specification, combined with the above several typical application scenarios, the method for UE to determine whether to transmit/receive positioning-related signal/channel through sidelink, and to determine the corresponding sidelink resources and transmit and receive positioning-related signal/channel on the resources will be explained.

In an exemplary embodiment, the first UE transmits and/or receives the signal/channel for positioning through sidelink, including at least one of positioning reference signal (PRS), sounding reference signal (SRS), positioning reference signal for sidelink, and configuration signaling related to positioning (e.g., it can be radio resource control (RRC)/medium access control (MAC)/physical layer (PHY) signaling). Wherein, the SRS for positioning is also referred as SRS-Pos, and in this specification, SRS is used for explanation. In this specification, the signal/channel for positioning transmitted and/or received through sidelink can be simply referred as sidelink positioning signal or SL PRS, including at least one of PRS, SRS, sidelink signal/channel and positioning reference signal for sidelink. This method is mainly used to simplify the description in the specification, but its name should not limit the scope of protection in this specification.

In this specification, a node can be at least one of the following: a base station, an LMF, and a sidelink UE.

In this specification, the reception of SL PRS can also include the measurement of SL PRS, and the description will not be repeated in everywhere.

In an exemplary embodiment, if the first UE needs to transmit and/or receive the SL PRS through the sidelink, it obtains from the higher layer and/or other nodes at least one of the following:
the resource pool for transmitting and/or receiving SL PRS, including obtaining the index and/or configuration of the resource pool;
the information of the resource set for transmitting and/or receiving SL PRS, including at least one of the following: resource set ID, period, time domain offset, repetition factor, time interval (e.g., it can be similar to dl-PRS-ResourceTimeGap in downlink positioning), mute configuration, resource list, comb size, bandwidth, start/end/used physical resource block (PRB), the number of symbols;
information of resources for transmitting and/or receiving SL PRS, including at least one of the following: resource ID, sequence ID, comb size and offset, time domain offset (including offset of slots and/or symbols), and quasi-co-location (QCL) information.

Further, the resource pool for transmitting and/or receiving SL PRS, further including any one of the following: resource pool for SL PRS, resource pool for data or resource pool for data and SL PRS. Alternatively, the configuration of the resource pool obtained by the UE includes the type of the resource pool. Alternatively, the indexes of different types of resource pools are calculated separately, or the indexes of all types of resource pools are calculated uniformly. Alternatively, the configuration of the resource pool for transmitting and/or receiving SL PRS can include an information list with N configurations, each configuration corresponds to at least one resource set for transmitting and/or receiving SL PRS and/or at least one resource for transmitting and/or receiving SL PRS; all of the N configurations can be used by the first UE, or the configuration of the resource pool indicates that M configurations among the N configurations are activated for use by the first UE, where N and M are positive integers. Alternatively, the configuration of the resource pool for transmitting and/or receiving SL PRS includes information in the configuration of the resource pool for data or a subset thereof, and/or includes at least one of the resource set for SL PRS below and information of resources for SL PRS. Alternatively, the configuration of the resource pool for transmitting and/or receiving the SL PRS indicates whether the SL PRS can be multiplexed on other sidelink signals/channels (such as PSSCH carrying data).

Alternatively, the first UE transmits the obtained above-mentioned at least one information to other nodes that assist the first UE in positioning and/or request the first UE to assist it in positioning, such as other nodes that receive and measure PRS/SRS transmitted by the first UE, and other nodes transmitting PRS/SRS to the first UE for measurement by the first UE.

Accordingly, if the second UE (or node) needs to assist the first UE (or node) in sidelink based positioning and/or request the first UE to assist it in positioning, at least one of the following is performed: obtaining the above-mentioned at least one information from the higher layer and/or other nodes, obtaining the above-mentioned at least one information from the first UE, and transmitting the above-mentioned at least one information to the first UE.

In an exemplary embodiment, the first UE receives the resource pool configuration indicated by the second UE on the sidelink, and selects the resources for the transmission in the resource pool. Alternatively, the resource pool configuration indicated by the second UE to the first UE is the resource pool obtained by the second UE from the base station, configured by the base station to the second UE, and/or the first UE or a subset thereof. Alternatively, the second UE reports to the base station that the first UE needs to transmit and/or receive SL PRS, obtains the information of the resource pool configured by the base station to the second UE and/or the first UE for the first UE to transmit and/or receive SL PRS, and transmits the information or a subset of the information to the first UE.

In another exemplary embodiment, the first UE receives the resource set configuration indicated by the second UE on the sidelink, and selects the resources for the transmission in the resource set. Alternatively, the resource set configuration indicated by the second UE to the first UE is the resource set obtained by the second UE from the base station, configured by the base station to the second UE, and/or the first UE or a subset thereof. Alternatively, the second UE reports to the base station that the first UE needs to transmit and/or receive SL PRS, obtains the information of the resource set configured by the base station to the second UE and/or the first UE for the first UE to transmit and/or receive SL PRS, and transmits the information or a subset of the information to the first UE.

In an exemplary embodiment, the first UE determines the resources for transmitting the SL PRS and/or transmits the SL PRS through a sidelink when at least one of the following conditions is satisfied:
configured to transmit SL PRS; wherein different SL PRS can be configured separately, for example, the first UE is configured to transmit SL PRS similar to DL PRS, the UE is configured to transmit SRS on the sidelink, or both are configured; wherein the first UE can be configured by the higher layer and/or other nodes;
the node that is expected to receive the SL PRS is the second UE, and the identity of the second UE satisfies the preset conditions, for example, in the preset UE ID set;
the node that is expected to receive the SL PRS is the second UE, and the geographical location of the second UE satisfies the preset conditions, for example, the geographical location is indicated by a zone ID, the zone ID is within a predetermined threshold range, and/or the distance between the first UE and the second UE preliminarily estimated according to the zone ID is within a predetermined threshold range;
the measurement result of a specific signal/channel satisfies the predetermined/(pre-) configured threshold range;
the measurement result of the specific signal/channel is invalid;
fails to detect a specific signal/channel;
the specific pathloss satisfies the predetermined/(pre-) configured threshold range; wherein the specific pathloss includes at least one of the downlink pathloss and sidelink pathloss, and the pathloss can be determined based on the measurement of any above specific signal/channel;
triggered by the higher layer to transmit SL PRS through sidelink, and/or receives signaling for triggering the first UE to transmit SL PRS through sidelink; in this specification, for the convenience of description, the signaling is called positioning TX request signaling, but its name should not limit the scope of protection.
receives information of resources, indicated by the higher layer or other nodes, for the first UE to transmit SL PRS through sidelink; the resources include at least one of a resource pool, an SL PRS resource set, and SL PRS resources.

Other signals/channels (such as PSCCH and/or PSSCH) will be transmitted, and SL PRS can be carried on the above other signals/channels.

In the above method, whether the first UE satisfies at least one of the above conditions can be used to decide whether to determine the resources for transmitting the SL PRS, or whether to transmit the SL PRS through sidelink, or to decide whether to determine the resources for transmitting the SL PRS and to decide whether to transmit the SL PRS through sidelink both.

In the above method, the specific signal/channel includes at least one of the following: a downlink synchronization signal/channel (e.g., SSB), PDCCH, PDSCH, a sidelink synchronization signal/channel (e.g., SL-SSB), PSCCH, PSSCH, PSFCH, a positioning signal (e.g., PRS) transmitted by the base station, and SL PRS transmitted by other UEs.

The measurement result can be a measurement result based on RSRP and/or angle (e.g. DL-AoD, UL-AoA) and/or time (e.g. DL/UL-TDOA, Multi-RTT); can be a measurement result of a positioning reference signal such as PRS and/or SRS; the measured positioning measurement value includes at least one of PRS RSTD, PRS RSRP, UE Rx-Tx time difference, RTOA, SRS RSRP, node Rx-Tx time difference and uplink/sidelink angle measurement value, wherein the node Rx-Tx time difference is similar to gNB Rx-Tx time difference, but the gNB in the definition can be replaced by other sidelink UEs.

For the scenario where the first UE is triggered by the positioning TX request signaling to transmit SL PRS, the conditions for the first UE to transmit SL PRS through sidelink further include at least one of the following:
the node transmitting the positioning TX request signaling is the base station or LMF, and further, the node transmitting the positioning TX request signaling is the serving cell of the first UE;
the node transmitting the positioning TX request signaling is the second UE, and the identity of the second UE satisfies the preset conditions, for example, in the preset UE ID set;
the geographical location indicated in the positioning TX request signaling or the geographical location of the node transmitting the positioning TX request signaling satisfies the preset conditions, for example, the geographical location is indicated by a zone ID, the zone ID is within a predetermined threshold range, and/or the distance between the first UE and the node transmitting the positioning TX request signaling preliminarily estimated according to the zone ID is within a predetermined threshold range;
the range of at least one of the following parameters corresponding to the positioning TX request signaling and/or the range of at least one of the following parameters corresponding to the node transmitting the positioning TX request signaling satisfies the preset conditions (e.g., within a predetermined threshold range): RSRP, pathloss, ToA, TDOA; wherein, the ToA and TDoA corresponding to the node of the positioning TX request signaling can be the ToA and TDOA obtained by the first UE measuring the node.

The node transmitting the positioning TX request signaling is the second UE, and the first UE establishes PC5 RRC connection with the second UE, and/or receives the sidelink signal/channel transmitted by this second UE, and/or transmits the sidelink signal/channel to the second UE; further, the first UE has received the sidelink signal/channel transmitted by this second UE and/or transmitted the sidelink signal/channel to the second UE within a predetermined time range;
positioning TX request signaling indicates that the node transmitting the positioning TX request signaling has the capability to assist other nodes in positioning;
positioning TX request signaling indicates the identity of the first UE;
positioning TX request signaling indicates the condition for transmitting SL PRS, and the first UE satisfies the condition.

In an exemplary embodiment, the first UE determines the resources for receiving the SL PRS and/or receives the SL PRS through sidelink and/or measures the received SL PRS when at least one of the following conditions is satisfied:
configured to receive SL PRS; wherein different SL PRS can be configured separately (similar to the conditions for the first UE transmits SL PRS), and the first UE can be configured by the higher layer and/or other nodes;
the node transmitting the SL PRS is the second UE, and the identity of the second UE satisfies the preset conditions, for example, in the preset UE ID set;
the node transmitting the SL PRS is the second UE, and the geographical location of the second UE satisfies the preset conditions, for example, the geographical location is indicated by a zone ID, the zone ID is within a predetermined threshold range, and/or the distance between the first UE and the second UE preliminarily estimated according to the zone ID is within a predetermined threshold range;
the measurement result of the specific signal/channel satisfies the predetermined/(pre-) configured threshold range;
the measurement result of the specific signal/channel is invalid;
fails to detect the specific signal/channel;
the specific pathloss satisfies the predetermined/(pre) configured threshold range;
wherein the specific pathloss includes at least one of downlink pathloss and sidelink pathloss, and the pathloss can be determined based on the measurement of any above specific signal/channel;
triggered by the higher layer to receive SL PRS through sidelink, and/or receives signaling for triggering the first UE to receive SL PRS through sidelink; in this specification, for the convenience of description, the signaling is called positioning RX request signaling, but its name should not limit the scope of protection.
receives information of resources, indicated by the higher layer or other nodes, for the first UE to receive SL PRS through sidelink;
other signals/channels (such as PSCCH and/or PSSCH) will be received, and SL PRS can be carried on the above other signals/channels.

In the above method, the decision of whether the first UE satisfies at least one of the above conditions can be made before determining resources for receiving SL PRS, before receiving SL PRS through sidelink, before measuring the received SL PRS, or the decision can be made before receiving resources for receiving SL PRS, before receiving SL PRS through sidelink and before measuring the received SL PRS.

In the above method, the specific signal/channel includes at least one of the following: a downlink synchronization signal/channel (e.g., SSB), PDCCH, PDSCH, a sidelink synchronization signal/channel (e.g., SL-SSB), PSCCH, PSSCH, PSFCH, a positioning signal (e.g., PRS) transmitted by base station, and SL PRS transmitted by other UEs. The measurement result can be a measurement result based on RSRP and/or angle (e.g. DL-AoD, UL-AoA) and/or time (e.g. DL/UL-TDOA, Multi-RTT); can be a measurement result of a positioning reference signals such as PRS and/or SRS; the measured positioning measurement value includes at least one of PRS RSTD, PRS RSRP, UE Rx-Tx time difference, RTOA, SRS RSRP, node Rx-Tx time difference and uplink/sidelink angle measurement value, wherein the node Rx-Tx time difference is similar to gNB Rx-Tx time difference, but the gNB in the definition can be replaced by other sidelink UEs.

For the scenario where the first UE is triggered by the positioning RX request signaling to receive SL PRS, the conditions for the first UE to receive SL PRS through sidelink further include at least one of the following:
the node transmitting the positioning RX request signaling is the base station or LMF, and further, the node transmitting the positioning RX request signaling is the serving cell of the first UE;
the node transmitting the positioning RX request signaling is the second UE, and the identity of the second UE satisfies the preset conditions, for example, in the preset UE ID set;
the geographical location indicated in the positioning RX request signaling or the geographical location of the node transmitting the positioning RX request signaling satisfies the preset conditions, for example, the geographical location is indicated by a zone ID, the zone ID is within a predetermined threshold range, and/or the distance between the first UE and the node transmitting the positioning RX request signaling preliminarily estimated according to the zone ID is within a predetermined threshold range;
the range of at least one of the following parameters corresponding to the positioning RX request signaling and/or the range of at least one of the following parameters corresponding to the node transmitting the positioning RX request signaling satisfies the preset conditions (e.g., within a predetermined threshold range): RSRP, pathloss, ToA, TDoA; wherein, the ToA and TDoA corresponding to the node of the positioning RX request signaling can be the ToA and TDOA obtained by the first UE measuring the node.

The node transmitting the positioning RX request signaling is the second UE, and the first UE establishes PC5 RRC connection with the second UE, and/or receives the sidelink signal/channel transmitted by the second UE, and/or transmits the sidelink signal/channel to the second UE; further, the first UE has received the sidelink signal/channel transmitted by this second UE and/or transmitted the sidelink signal/channel to the second UE within a predetermined time range;
positioning RX request signaling indicates that the node transmitting the positioning RX request signaling has the capability to assist other nodes in positioning;
positioning RX request signaling indicates the identity of the first UE;
positioning RX request signaling indicates the condition for receiving SL PRS, and the first UE satisfies the condition.

FIG. 5 schematically illustrates a flowchart of determining resources for transmitting the sidelink positioning signal according to an embodiment of the disclosure.

Referring FIG. 5, in operation 501, the first node may obtain the resources scheduled/configured by other nodes. In operation 502, the first node may determine the resources and/or resource set for transmitting the sidelink positioning signal based on the channel monitoring result.

When the first UE transmits the SL PRS through sidelink, it needs to determine the resources used to transmit the SL PRS, including at least one of the time domain resources, frequency domain resources, spatial domain resources, and code domain resources, and further including at least one of the following corresponding to the resources: resource set ID, period, time domain offset, repetition factor, time interval (e.g., similar to dl-PRS-ResourceTimeGap in downlink positioning), mute configuration, resource list, comb size, bandwidth, start/end/used PRB, the number of symbols, resource ID, sequence ID, comb size and offset, time domain offset (including offset of slots and/or symbols), QCL information, index of beam used by SL PRS.

Alternatively, when the first UE receives the SL PRS through sidelink, it also needs to determine the resources for the reception, including at least one of the time domain resources, frequency domain resources, spatial domain resources and code domain resources, and further including the at least one item above corresponding to the resources, and only measure the SLPRS on the resources that should be received; and/or, when the first UE receives the SL PRS through the sidelink, the whole resource pool is detected blindly and the specific SLPRS is measured based on the at least one item above; and/or, when the first UE receives the SL PRS through the sidelink, the whole resource pool is detected blindly and any detected SL PRS is measured.

Wherein since sequence index and cyclic shift are typical methods for distinguishing sequences in communication systems, and beam index is a method for distinguishing spatial domain resources in typical spatial multiplexing methods, the method can also be understood as determining the code domain/spatial domain resources used by the first UE to transmit SL PRS.

The first UE determines resources for the transmission by at least one of the following methods:
the first UE obtains resources scheduled/configured by other nodes, which can be at least one of a base station, an LMF, and other sidelink UEs;
according to the channel monitoring result, and further according to the sensing, the resources for the transmission are determined.

Alternatively, the first UE determines the resources for the reception through the obtained resources scheduled/configured by other nodes, and/or determines the resources for the reception according to the resource pool configuration.

Wherein the resources scheduled/configured by other nodes can be at least one of periodic, semi-static, and dynamic; the resources can be dedicated to UE, such as specific resources in a resource set or a resource set (alternatively used by a given UE), or can be shared by multiple UEs, such as a resource set or a configured resource pool (alternatively used by multiple UEs). For the resources dedicated to the UE, the first UE can directly use the resources to transmit the SL PRS.

For the resource pool and/or resource set, in which the first UE further selects the resources for the transmission. For example, the first UE obtains a resource pool scheduled/configured by the base station or other sidelink UEs, and determines the resources for the transmission according to the sensing result in the resource pool.

In an exemplary embodiment, the first UE obtains the configuration of a resource pool for transmitting SL PRS, and further selects resources for the transmission in the resource pool, including selecting a resource set in the resource pool and using the resource set to transmit SLPRS; and/or, selecting at least one resource from the resource set and the using the resource to transmitting the SL PRS. Further, the method includes at least one of the following methods:
according to specific parameters and/or configurations, selecting a resource set in the resource pool. Wherein the specific parameters include at least one of the following: UE identity (which can be the identity of the first UE, such as source ID); and/or identities of other UEs, (such as destination ID corresponding to SL PRS), identity of the UE within a UE group (such as intra-group index corresponding to UE itself within a group of UE corresponding to a group ID), geographic location related information (such as latitude and longitude, zone ID), priority, offset parameters and/or index parameters indicated by higher layer or other nodes for determining SL PRS resources. The information in the configuration includes at least one of the following: resource pool for transmitting and/or receiving SL PRS, information of resource set for transmitting and/or receiving SL PRS, and information of resources for transmitting and/or receiving SL PRS. The UE can determine all or part of the configuration of the resource set based on specific parameters, and/or obtain all or part of the configuration of the resource set from higher layer/other nodes, and select the resource set corresponding to the configuration from the resource pool according to the configuration determined based on specific parameters and/or the configuration obtained from higher layer/other nodes;
according to the channel monitoring result, selecting a resource set in the resource pool; further, selecting a resource set in the resource pool based on the sensing.

Similarly, the UE can also use at least one of the above methods to select a resource set in the resource pool and/or at least one resource in the resource set, and use the resource set/resource to receive SL PRS.

Wherein the resource set used by different SL PRS (such as SL PRS similar to DL PRS and SL PRS similar to SRS, and other channels for positioning, such as configuration signaling related to positioning) can be selected separately or together, and the resource set transmitted to different nodes (such as different other sidelink UEs) for use can be selected separately or together. Alternatively, the resource set is selected together or separately based on the use of transmitting SL PRS, for example, based on transmitting the SL PRS since the first UE itself needs be to positioned or transmitting the SL PRS by the first UE to other nodes since other nodes need to be positioned, selects the same and different resources to transmit the SL PRS separately; and/or, based on the attributes or requirements of other nodes that will receive the SL PRS, for example, when the IDs of other nodes that will receive the SL PRS belong to different UE groups or correspond to different positioning resources, transmit the SL PRS on different resources separately, otherwise, transmit the SL PRS to other nodes on the same resource, for another example, when the first UE transmits the SL PRS for the positioning requirements of other UEs, and other UEs indicate the expected resource set or resource range for receiving SL PRS, the first UE transmits the SL PRS to the UE on the resources indicated by other UEs separately; and/or, based on the SL PRS is transmitted independently or multiplexed with other signals/channels, for example, the first UE transmits the SL PRS on the same resource when the SL PRS is transmitted independently, and the first UE transmits the SL PRS separately according to the resources used by other signals/channels (e.g., data channel PSSCH) multiplexed to transmit other UEs when the SL PRS is multiplexed with other signals/channels.

According to the channel monitoring result (further, according to the sensing), the first UE determines the resources for transmitting the SL PRS and/or selects a resource set in the resource pool, including at least one of the following methods:
on the basis of the sensing method for PSSCH, replace the corresponding parameters of data used in the sensing process by at least one of the following parameters of SL PRS, and sense SL PRS resources occupied by other nodes, and select among the SL PRS resources not occupied by other nodes: resource pool (including sidelink resource pool for positioning and/or resource set for SL PRS in sidelink resource pool), priority, transmission delay of SL PRS (alternatively, the range of delay, such as maximum/minimum delay), resource size in the time domain and/or frequency domain, transmission period, processing delay. Alternatively, the method is used when the SL PRS is transmitted independently (i.e. not multiplexed on other signals/channels);
according to at least one parameter of the resource pool of SL PRS, priority, transmission delay of SL PRS (alternatively, the range of delay, such as maximum/minimum delay), resource size in the time domain and/or frequency domain, transmission period, and resource pattern of SL PRS, sense the SL PRS resources occupied by other nodes or the occupied resource pattern, and select from the SL PRS resources or resource patterns not occupied by other nodes; wherein, the pattern includes at least one of the period of SL PRS, time-domain offset, repetition factor, mute configuration and the above parameters for determining SL PRS resources/resource set.

Monitor the indicating signal/channel of SL PRS resources, determine the SL PRS resources occupied by other nodes according to the information of SL PRS resources indicated in the indicating signal/channel, and select from the SL PRS resources not occupied by other nodes.

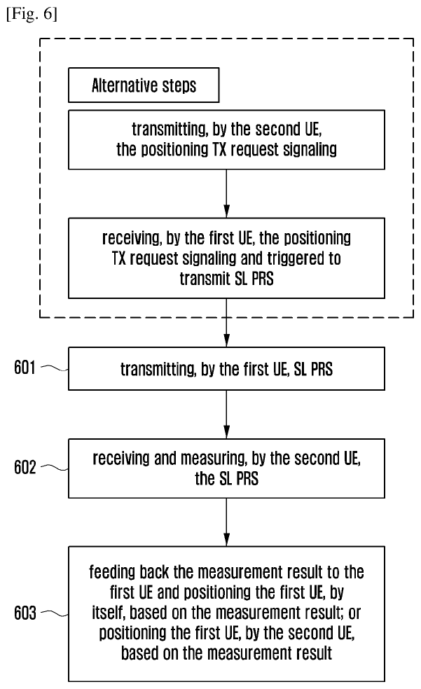

FIG. 6 schematically illustrates the embodiment 1 according to an embodiment of the disclosure.

In this embodiment, the first UE transmits the SL PRS in a sidelink resource pool (operation 601), and at least one second UE receives the SL PRS and measures the SL PRS (operation 602). The second UE feeds back the measurement result to the first UE, and the first UE performs positioning according to the received measurement result; or the second UE performs positioning according to its own measurement result. The positioning determines the location of the first UE (operation 603).

In this embodiment, the sidelink resource pool for the first UE to transmit SL PRS can be (pre-) configured, including configured by the base station/higher layer/other UEs, or (pre-) defined. Alternatively, the sidelink resource pool can be a resource pool dedicated to positioning, or a resource pool that can be used for positioning and data transmission. Alternatively, the first UE can be (pre-) configured with two types of resource pools: a resource pool dedicated to positioning, a resource pool that can be used for positioning and data transmission or a resource pool that can be used for data transmission; the indexes of the two resource pools are calculated separately or together. Alternatively, the configuration also indicates whether the resource pool can be used for data transmission and/or positioning signal/channel transmission. Further, the indication is only indicated in the case where the resource pool indexes are calculated together and/or separately. Any of the above resource pools can further include a transmission resource pool and/or a reception resource pool for UE to transmit and/or receive corresponding signals/channels therein.

The information of the sidelink resource pool the first UE configured with can include any information of resource pool configuration for data transmission in the current technology, and can also include at least one of the following: information of resource set for transmitting and/or receiving SL PRS in the resource pool, information of resources for transmitting and/or receiving SL PRS in the resource pool. Alternatively, whether the resource set and/or the resources for transmitting and/or receiving SL PRS can be used for transmitting and/or receiving data is (pre-) defined and/or (pre-) configured, for example, indicated in the resource pool configuration; and/or, whether the SL PRS can be multiplexed on other sidelink signals/channels (e.g., PSSCH that carries data) is (pre-) defined and/or (pre-) configured. The configuration of the sidelink resource pool and the following specific examples can also be used in other embodiments such as t embodiment 2, and will not be repeated in each embodiment.

In a specific example, the first UE transmits the SL PRS in a configured sidelink resource pool dedicated to positioning. The first UE only needs to attempt to avoid conflict with the SL PRS transmitted by other UEs when determining the resources for transmitting the SL PRS, without considering the interference of the data channel. For example, when the first UE performs channel monitoring to determine the transmission resources of SL PRS, it does not monitor the data channel, and/or when the first UE determines the transmission resources of SL PRS based on channel sensing, it only monitors the channel based on SL PRS rather than data (e.g., not based on PSSCH and/or PSCCH).

In another specific example, the first UE transmits the SL PRS in a configured sidelink resource pool that can be used for positioning and data transmission, and in this resource pool, the resource set and/or resources for transmitting and/or receiving the SL PRS cannot be used for transmitting and/or receiving data, and the SL PRS cannot be multiplexed on the PSSCH/PSCCH, and similar to the previous example, the first UE only needs to attempt to avoid conflict with the SL PRS transmitted by other UEs when determining resources for transmitting the SL PRS. In this example, the first UE needs to obtain the resource set and/or resources configured for transmitting the SL PRS in the resource pool, and can only select the transmission resources of the SL PRS from the resource set and/or resources.

In another specific example, the first UE transmits the SL PRS in a configured sidelink resource pool that can be used for positioning and data transmission, and in this resource pool, the resource set and/or resources for transmitting and/or receiving the SL PRS can be used for transmitting and/or receiving data, and/or the SL PRS cannot be multiplexed on the PSSCH/PSCCH, and the first UE needs to consider the interference of the SL PRS transmitted by other UEs and the interference of the data transmitted by other UEs when determining resources for transmitting the SL PRS.

Alternatively, if the first UE is configured to transmit SL PRS (e.g., the parameters corresponding to transmitting SL PRS are configured to be enabled by RRC), and the measurement result (e.g., RSRP, RSRQ) of synchronization signal/channels (e.g., SSB, S-SSB) transmitted by the base station and/or the second UE is lower than a specific threshold, the first UE can transmit SL PRS. Alternatively, the second UE is the synchronization source UE of the first UE, or the second UE is any other sidelink UEs. The advantage of this condition is that the measurement result of SSB of DL/SL is lower than the threshold value, which indicates that the first UE is at the coverage edge of the base station/the second UE, and at this time, it is difficult for the first UE to obtain the accurate positioning result directly by measuring the positioning signal transmitted by the base station/second UE, and the first UE can perform more accurate positioning by actively transmitting SL PRS and triggering other UEs to measure it. Similarly, the pathloss can also be used as one of the conditions for the first UE to actively transmit SL PRS.

Alternatively, if the first UE fails to detect the positioning signal transmitted by the base station and/or the second UE or measures the positioning signal transmitted by the base station and/or the second UE, but the measurement result does not satisfy the relevant requirements of the positioning technology such as measurement accuracy and measurement density (e.g., the measurement result such as RSTD, Rx-Tx time difference does not satisfy the requirements in Section 10.1.23 of TS38.133 protocol), that is the measurement result is invalid, the first UE can transmit SL PRS. The motivation and advantages of this condition are similar to those of the previous conditions, the first UE can actively transmit SL PRS for more accurate positioning when it is difficult to obtain accurate positioning results directly by measuring the existing signals/channels.

Alternatively, the first UE can be triggered to transmit the SL PRS by the positioning TX request signaling transmitted by the base station or the second UE. In the scenario where the first UE transmits SL PRS to implement the positioning of the first UE, the positioning TX request signaling transmitted by the second UE can be used to indicate that the second UE can assist the first UE in positioning, such as indicating that the second UE has the capability to measure positioning signal; and/or indicating the identity of the second UE, which is used for the first UE to identify whether the second UE is the specific UE, such as whether the second UE is in the same communication group with the first UE or whether the second UE establishes PC5 RRC connection with the first UE. In addition, the positioning TX request signaling transmitted by the second UE can also be used as a response to the SL PRS or related signaling transmitted by the first UE, for example, the first UE broadcasts/groupcasts a request for other UEs to assist in measuring the SL PRS transmitted by the first UE, and the second UE transmits the positioning TX request signaling as an acknowledge response to the request. In the example, the first UE can transmits the SL PRS after obtaining the positioning TX request signaling transmitted by the second UE and determining that the SL PRS transmitted by itself can be measured by the second UE and assist the first UE in positioning, otherwise, the first UE will not transmit the SL PRS to save overhead and reduce network load.

Further, the first UE can be triggered to transmit SL PRS by the positioning TX request signaling transmitted by the base station or the second UE, and further includes: the first UE can be triggered to transmit SLPRS by the positioning TX request signaling transmitted by the base station or the second UE when the time of receiving the positioning TX request signaling satisfies the requirement of the processing delay of the UE; and/or, after receiving the positioning TX request signaling, the first UE can only transmit the SL PRS after a time length including at least the processing delay of the UE.

In a specific example, the first UE receives the positioning TX request signaling transmitted by the base station or the second UE on the slot n, and the resources determined by the first UE or indicated by the higher layer/other nodes for transmitting SL PRS are on the slot m, the first UE can transmit SL PRS on the slot m when m-n is greater than the threshold of the processing delay of the corresponding UE, otherwise, the first UE will not transmit SL PRS or transmit SL PRS on the next resource that can satisfy the delay requirement.

For the transmission resources of SL PRS, similar to the UL/DL positioning technology, the first UE can obtain specific resources or resource set scheduled by the base station for transmission of one/a group of SL PRS. However, the disadvantage of this method is that it depends heavily on the scheduling of the base station, and more flexible and diverse layouts cannot be supported, especially the out-of-coverage scenarios in SL positioning requirements. A feasible method is that the first UE obtains specific resources/resource set scheduled by other sidelink UEs. However, this method still has some limitations on the centralization of the network layout. For example, it can only be used in the scenario where there are Road Side Units (RSU) or in the scenario where the sidelink UE has the capability to act as a central scheduling node. Therefore, this specification also provides other methods for determining specific resources for transmitting SL PRS, including according to parameters such as UE ID, geographic location information, priority, selecting corresponding indexed resource set/resources according to the predetermined mapping rules, and selecting resource set/resources that are not occupied or reserved by other UEs based on channel monitoring including channel sensing. The above methods can also be used in other embodiments, such as the embodiment 2, and the description will not be repeated in each embodiment.

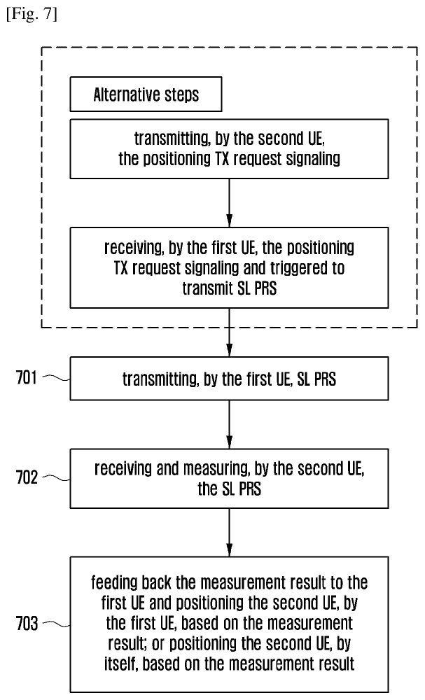

FIG. 7 schematically illustrates the embodiment 2 according to an embodiment of the disclosure.

The basic steps in this embodiment are same as those in the first embodiment, that is, the first UE transmits the SL PRS in a sidelink resource pool (operation 701), and at least one second UE receives the SL PRS and measures the SL PRS (operation 702); the second UE feeds back the measurement result to the first UE, and the first UE performs positioning according to the received measurement result, or the second UE performs positioning according to its own measurement result (operation 703). However, different from the first embodiment, the positioning determines the location of the second UE.

In this embodiment, alternatively, if the first UE is configured to transmit the SL PRS, and the measurement result of the synchronization signal/channel transmitted by the base station and/or the second UE is lower than a specific threshold, and/or the positioning signal transmitted by the base station and/or the second UE fails to be detected, or the positioning signal transmitted by the base station and/or the second UE is measured but the measurement result does not satisfy the requirements of the positioning technology, the first UE can transmit the SL PRS.

Alternatively, the first UE periodically broadcasts/groupcasts the SL PRS for the use of the surrounding potential second UE that needs to measure the SL PRS for positioning, and/or the first UE is triggered to transmit the SL PRS after receiving the positioning TX request signaling transmitted by the base station or the second UE. In the scenario where the first UE transmits SL PRS to implement the positioning of the second UE, in order to save overhead and avoid unnecessary transmission of SL PRS, the first UE can determine whether it is necessary to respond to the second UE transmitting the positioning TX request signaling. For example, the positioning TX request signaling indicates the identity of the second UE transmitting the signaling, and the first UE determines whether the identity of the second UE is in the preset ID set to avoid transmitting SL PRS for the unrelated second UE; or the first UE determines whether a PC5 RRC connection has been established with the second UE, and only transmits the SL PRS for the second UE that has established the connection. For example, the positioning TX request signaling indicates the zone ID of the second UE transmitting the signaling, and the first UE calculates the distance from the second UE according to the zone ID, and only transmits the SL PRS when the distance is less than a specific threshold, so that after the second UE transmits the positioning TX request signaling, only the first UE that is closer to the second UE will transmit the SL PRS. For example, after receiving the positioning TX request signaling, the first UE measures the signaling or other sidelink signals/channels transmitted by the second UE transmitting the signaling. Only when the measured RSRP is higher than the threshold, or the pathloss is lower than the threshold, or ToA/TDoA satisfies the predetermined threshold range, the first UE will transmit the SL PRS.

Similarly, the first UE can be triggered to transmit SLPRS by the positioning TX request signaling transmitted by the base station or the second UE when the time of receiving the positioning TX request signaling satisfies the requirement of processing delay of the UE; and/or, after receiving the positioning TX request signaling, the first UE can only transmit the SL PRS after a time length including at least the processing delay of the UE. Further, the positioning TX request signal indicates the resources or the range of resources that the first UE is expected to transmit SL PRS, and when the resources/resource range satisfies the delay requirement, it is considered that the resources indicated in the positioning TX request signal is the resources scheduled by the second UE to the first UE for transmitting SL PRS, or the resources for transmitting SL PRS are determined within the resource range indicated in the positioning TX request signal.

In a specific example, m resource sets are indicated in the positioning TX request signaling, and the first UE selects the resource set indexed UE ID mod m according to its own ID, and starts transmitting SL PRS on the earliest resource in the resource set that satisfies the delay requirement.

In another specific example, the positioning TX request signaling indicates the time range slot [n1, n2] in which the second UE is expected to measure the SL PRS, and the first UE selects the resources for transmitting the SL PRS within [n1, n2] based on the channel sensing. Alternatively, the first UE selects the SL PRS transmission resources as close as possible to the slot n1, so that the SL PRS transmitted by a plurality of first UEs are in the shortest time range, and the positioning accuracy of the measured SL PRS is improved. In this example, [n1, n2] can be indicated explicitly or implicitly in the positioning TX request signaling, for example, n1=n+ processing delay of the UE, and n is the slot where the positioning TX request signaling is located; n2 is based on the positioning accuracy requirement (which can be based on priority). When the maximum time span of SL PRS distribution corresponding to the positioning accuracy requirement is Tmax, n2=n1+Tmax.

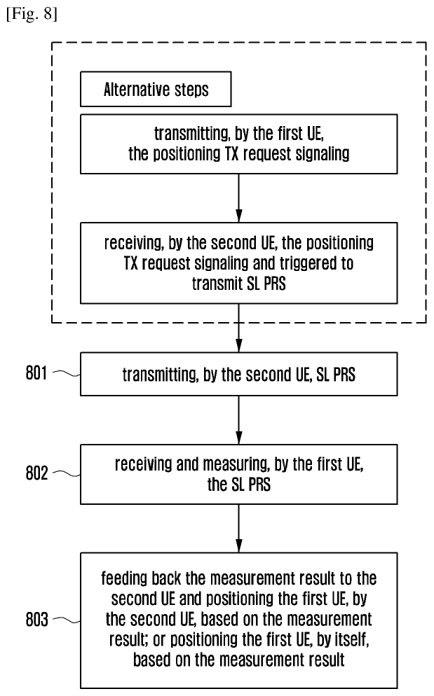

FIG. 8 schematically illustrates the embodiment 3 according to an embodiment of the disclosure.

In this embodiment, at least one second UE transmits the SL PRS in a sidelink resource pool (operation 801), and the first UE receives the SL PRS and measures the SL PRS (operation 802). The first UE feeds back the measurement result to the second UE, and the second UE performs positioning according to the received measurement result; or the first UE performs positioning according to its own measurement result. The positioning determines the location of the first UE (operation 803).

Alternatively, if the first UE is configured to receive SL PRS (e.g., the parameters corresponding to the received SL PRS are configured to be enabled by RRC), and obtains the sidelink resource pool in which the SL PRS can be received, the first UE detects the SL PRS in the resource pool blindly and measures the SL PRS. Alternatively, if the UE is configured to receive SL PRS and configured to receive SL PRS corresponding to specific values of specific resources/specific resource set/parameters, the first UE may not detect all SL PRS in the resource pool blindly, but only the potential SL PRS corresponding to the configuration. This method can also be used in the embodiment 4t, and the description will not be repeated.

Alternatively, for the detected SL PRS, the first UE only measures the SL PRS when the ID of the second UE that transmitting the SL PRS belongs to a specific set, or PC5 RRC connection with the second UE has been established, or the geographical distance of the second UE is lower than the threshold. Alternatively, only when the measured RSRP is higher than the threshold, or the pathloss is lower than the threshold, or the ToA/TDoA satisfies the predetermined threshold range, the first UE feeds back the measurement result to the second UE or performs positioning based on the measurement result.

Alternatively, if the first UE is configured to transmit SL PRS (e.g., the parameters corresponding to transmitting SL PRS are configured to be enabled by RRC), and the measurement result (e.g., RSRP, RSRQ) of synchronization signal/channels (e.g., SSB, S-SSB) transmitted by the base station and/or the third UE is lower than a specific threshold, the first UE can receive the SL PRS. Alternatively, the third UE is the synchronization source UE of the first UE, or the second UE transmitting the SL PRS, or any other sidelink UEs. The advantage of this condition is that the measurement result of SSB of DL/SL is lower than the threshold value, which indicates that the first UE is at the coverage edge of the base station/the third UE, and at this time, if the uplink or downlink positioning based on the base station is unavailable or its accuracy is difficult to guarantee, the first UE can perform more accurate positioning by receiving and measuring SL PRS. Similarly, the pathloss can also be used as one of the conditions for the first UE to receive the SL PRS.

Alternatively, if the first UE fails to detect the positioning signal transmitted by the base station and/or the second UE, or the positioning signal transmitted by the base station and/or the second UE is measured but the measurement result does not satisfy the relevant requirement of the positioning technology, such as measurement accuracy, measurement density, that is the measurement result is invalid, the first UE can transmit a positioning TX request signal to trigger the surrounding second UE to transmit SL PRS, and receive the SL PRS for measurement so as to position itself. The motivation and advantages of this condition are similar to those of the previous conditions. The first UE can actively transmit SL PRS for more accurate positioning when it is difficult to obtain accurate positioning results directly by measuring the existing signals/channels.

Alternatively, the first UE can be triggered to receive the SL PRS by the positioning RX request signaling transmitted by the base station or the second UE. In the scenario where the first UE receives the SL PRS to implement the positioning of the first UE, the positioning RX request signaling transmitted by the second UE can be used to indicate which first UE should receive and measure the SL PRS from the second UE, and can also be used to indicate the resources or the range of resources corresponding to the reception, thereby the overhead of blindly detect SL PRS by the first UE can be reduced.

The first UE receiving the SL PRS further includes receiving and measuring the SL PRS within the maximum time span Tmax of the SL PRS distribution corresponding to the positioning accuracy requirement. The value of Tmax and how to determine the start/end of Tmax can be configured by higher layer/base station/other nodes, or can be determined according to predetermined criteria. In a specific example, the first UE receives the SL PRS periodically, and receives and measures the SL PRS in the first Tmax time in the measurement window in each period. In another specific example, the starting point of the maximum time span Tmax corresponds to the slot in which the strongest SL PRS received by the first UE (in one period) is located, or the slot in which the earliest SL PRS received by the first UE (in one period) is located, or the slot in which the SL PRS of the LoS path received by the first UE (in one period) is located.

The advantage of this method is that, since the sidelink node can have high mobility in the sidelink based positioning scenario, the rapid change of its location will affect the accuracy of the positioning result. Therefore, limiting the measurement time span to a certain range can make the positioning results measured by UE satisfy the business requirements.

Further, the first UE can be triggered to receive SL PRS by the positioning RX request signaling transmitted by the base station or the second UE, and further includes: the first UE can be triggered to receive SLPRS by the positioning RX request signaling transmitted by the base station or the second UE when the time of receiving the positioning RX request signaling satisfies the requirement of for the processing delay of the UE; and/or, after receiving the positioning TX request signaling, the first UE can only transmit the SL PRS after a time length including at least the processing delay of the UE.

In a specific example, the first UE receives the positioning RX request signaling transmitted by the base station or the second UE on the slot n, and the resources determined by the first UE or indicated by the higher layer/other nodes or indicated in the positioning RX request signaling are on the slot m, the first UE can receive SL PRS on the slot m when m-n is greater than the threshold of the processing delay of the corresponding UE, otherwise, the first UE will not receive SL PRS or receive SL PRS on the next resource that can satisfy the delay requirement.

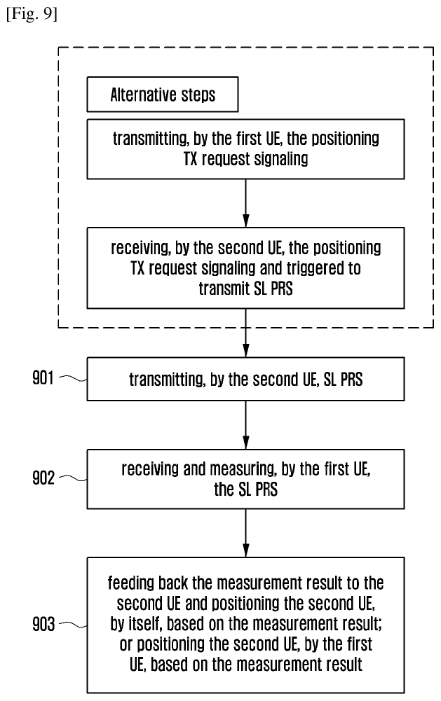

FIG. 9 schematically illustrates the embodiment 4 according to an embodiment of the disclosure. The basic steps in this embodiment are same as those in the embodiment 3, that is, at least one second UE transmits the SL PRS in a sidelink resource pool (operation 901), and the first UE receives the SL PRS and measures the SL PRS (operation 902); the first UE feeds the measurement result back to the second UE, and the second UE performs positioning according to the received measurement result, or the first UE performs positioning according to its own measurement result (operation 903). However, different from the third embodiment, the positioning determines the location of the second UE.

Alternatively, if the first UE is configured to transmit the SL PRS, and the measurement result of the synchronization signal/channel transmitted by the base station and/or the second UE is lower than a specific threshold, the first UE can receive the SL PRS. Alternatively, the third UE is the synchronization source UE of the first UE, or the third UE is not the second UE transmitting the SL PRS, or the third UE is any other sidelink UEs. The advantage of this condition is that the measurement result of SSB of DL/SL is lower than the threshold value, which indicates that the first UE is at the coverage edge of the base station/the third UE, and at this time, if the uplink or downlink positioning based on the base station is unavailable or its accuracy is difficult to guarantee, the first UE can perform more accurate positioning by receiving and measuring SL PRS. Similarly, the pathloss can also be used as one of the conditions for the first UE to receive the SL PRS.

Alternatively, the first UE can be triggered to receive the SL PRS by the positioning RX request signaling transmitted by the base station or the second UE. In the scenario where the first UE receives the SL PRS to implement the positioning of the second UE, the positioning RX request signaling transmitted by the second UE can be used to indicate which first UE should receive and measure the SL PRS from the second UE, and can also be used to indicate the resources or the range of resources corresponding to the reception, thereby the overhead of blindly detect SL PRS by the first UE can be reduced. The positioning RX request signaling transmitted by the second UE can also be used to indicate the information of the second UE transmitting the signaling, such as UE ID, zone ID, etc., for the first UE to determine whether it is necessary to receive the SL PRS transmitted by the second UE, and/or to determine the resources/resource set for receiving the SL PRS transmitted by the second UE.

Alternatively, after receiving the positioning RX request signaling, the first UE measures the signaling, or measures other sidelink signals/channels transmitted by the second UE that transmitted the signaling. Only when the measured RSRP is higher than the threshold, or the pathloss is lower than the threshold, or ToA/TDoA satisfies the predetermined threshold range, the first UE will receive the SL PRS from the second UE.

Further, the first UE can be triggered to receive SL PRS by the positioning RX request signaling transmitted by the base station or the second UE, and further includes: the first UE can be triggered to receive SLPRS by the positioning RX request signaling transmitted by the base station or the second UE when the time of receiving the positioning RX request signaling satisfies the requirement of the processing delay of the UE; and/or, after receiving the positioning TX request signaling, the first UE can only transmit the SL PRS after a time length including at least the processing delay of the UE.

The application also discloses an electronic device, the electronic device includes a memory configured to store a computer program; and a processor configured to read the computer program from the memory and execute the computer program to implement the above method.

The term “module” may refer to a unit including one of hardware, software, firmware, or a combination thereof. The term “module” can be used interchangeably with the terms “unit”, “logic”, “logic block”, “component” and “circuit”. The term “module” can indicate the smallest unit or part of an integrated component. The term “module” may indicate the smallest unit or part that performs one or more functions. The term “module” means a device that can be implemented mechanically or electronically. For example, the term “module” may indicate a device including at least one of an application specific integrated circuit (ASIC), a field programmable gate array (FPGA) or a programmable logic array (PLA) that performs certain operations that are known or will be developed in the future.

According to embodiments of the disclosure, at least a part of a device (e.g., a module or its function) or a method (e.g., an operation) can be implemented as instructions stored in a non-transitory computer-readable storage medium, for example, in the form of a programmed circuit. When performed by a processor, the instructions can enable the processor to perform corresponding functions. The non-transitory computer-readable storage medium may be, for example, a memory.

Non-transitory computer-readable storage media may include hardware devices such as hard disks, floppy disks, and magnetic tapes (e.g., magnetic tapes), optical media such as compact disk read-only memory (ROM) (CD-ROM) and digital versatile disk (DVD), magneto-optical media such as compact disks, ROM, random access memory (RAM), flash memory, etc. Examples of programs can include not only machine language codes but also high-level language codes that can be executed by various computing devices using interpreters. The above-mentioned hardware devices can be configured to operate as one or more software modules to execute the embodiments of the disclosure, and vice versa.

Circuits or programming circuits according to various embodiments of the disclosure may include at least one or more of the aforementioned components, omit some of them, or also include other additional components. Operations performed by circuits, programmed circuits, or other components according to various embodiments of the disclosure may be performed sequentially, simultaneously, repeatedly, or heuristically. In addition, some operations may be performed in a different order, or omitted, or include other additional operations.

The embodiments of the disclosure are described to facilitate understanding of the disclosure, but are not intended to limit the scope of the disclosure. Therefore, the scope of the disclosure should be interpreted to include all changes or various embodiments based on the scope of the disclosure defined by the appended claims and their equivalents.

1. A method performed by a first node in a communication system, the method comprising:
determining resources for transmitting a sidelink positioning signal; and
transmitting the sidelink positioning signal on the determined resources.

2. The method of claim 1, wherein the sidelink positioning signal includes at least one of:
a positioning reference signal (PRS), a sounding reference signal (SRS), a positioning reference signal for sidelink, or configuration signaling related to positioning.

3. The method of claim 1, wherein at least one of determination of the resources for transmitting the sidelink positioning signal or transmission of the sidelink positioning signal is performed in case that the first node satisfies at least one of the following conditions:
being configured to transmit the sidelink positioning signal;
an identity of a node receiving the sidelink positioning signal satisfies preset conditions;
a geographical position of a node receiving the sidelink positioning signal satisfies the preset conditions;
a measurement result of at least one of a specific signal or a channel satisfies a first threshold range;
a measurement result of the at least one of the specific signal or the channel is invalid;
fails to detect at least one of the specific signal or the channel;
a specific pathloss satisfies a second threshold range;
triggered by a higher layer to perform at least one of transmitting the sidelink positioning signal, or receiving a first signaling for triggering the first node to transmit the sidelink positioning signal; or
obtains information of resources, indicated by the higher layer or other nodes, for the first node to transmit the sidelink positioning signal.

4. The method of claim 3, wherein at least one of the specific signal or the channel includes at least one of: a downlink synchronization signal, a physical downlink control channel (PDCCH), a physical downlink shared channel (PDSCH), a sidelink synchronization signal, a physical sidelink control channel (PSCCH), a physical sidelink shared channel (PSSCH), a physical sidelink feedback channel (PSFCH), or a positioning signal transmitted by other nodes.

5. The method of claim 3, wherein in the case that the first signaling is received, the sidelink positioning signal is transmitted in case that the first node further satisfies at least one of the following conditions:
the node transmitting the first signaling is a base station or a location management function (LMF);
the identity of the node transmitting the first signaling satisfies the preset conditions;
the geographical location indicated by the first signaling or the geographical location of the node transmitting the first signaling satisfies the preset conditions;
the range of parameters corresponding to the first signaling satisfies the third threshold range;
the range of parameters corresponding to the node transmitting the first signaling satisfies the fourth threshold range;
the node transmitting the first signaling has established a connection with the first node or communicated with the first node;
the node transmitting the first signaling has the capability to assist other nodes in positioning is indicated in the first signaling;
the identity of the first node is indicated in the first signaling; or
a condition for transmitting the sidelink positioning signal is indicated in the first signaling, and the first node satisfies the indicated condition.

6. The method of claim 1, wherein determining the resources for transmitting the sidelink positioning signal comprises: obtaining resources which are scheduled or configured by other nodes,
wherein at least one of the following is obtained from a higher layer or the other nodes in case of obtaining the resources which are scheduled or configured by other nodes:
information of a resource pool for transmitting the sidelink positioning signal;
information of a resource set for transmitting the sidelink positioning signal; or
information of resources for transmitting the sidelink positioning signal,
wherein determining the resources for transmitting the sidelink positioning signal further comprises at least one of:
determining at least one of resources or the resource set for transmitting the sidelink positioning signal in the resource pool based on at least one of specific parameters or configurations;
determining at least one of resources or the resource set for transmitting the sidelink positioning signal in the resource pool based on the channel monitoring result;
determining resources for transmitting the sidelink positioning signal in the resource set based on at least one of specific parameters or configurations; or
determining resources for transmitting the sidelink positioning signal in the resource set based on the channel monitoring result.

7. The method of claim 1, further comprising:
obtaining a measurement result of the sidelink positioning signal; and
determining, based on the measurement result, position information for at least one of the first node or a second node, wherein the second node is a node configured to measure the sidelink positioning signal.

8. A method performed by a first node in a communication system, the method comprising:
determining resources for receiving a sidelink positioning signal;
receiving the sidelink positioning signal on the determined resources; and
measuring the sidelink positioning signal.

9. The method of claim 8, wherein the sidelink positioning signal includes at least one of:
a positioning reference signal (PRS), a sounding reference signal (SRS), a positioning reference signal for sidelink, or configuration signaling related to positioning.

10. The method of claim 8, wherein at least one of determination of the resources for receiving the sidelink positioning signal, reception of the sidelink positioning signal, or measurement of the sidelink positioning signal is performed in case that the first node satisfies at least one of the following conditions:
being configured to receive the sidelink positioning signal;
an identity of a node transmitting the sidelink positioning signal satisfies preset conditions;
a geographical position of a node transmitting the sidelink positioning signal satisfies the preset conditions;
a measurement result of at least one of a specific signal or a channel satisfies a first threshold range;
a measurement result of at least one of the specific signal or the channel is invalid;
fails to detect the at least one of the specific signal or the channel;
a specific pathloss satisfies a second threshold range;
triggered by a higher layer to perform at least one of receiving the sidelink positioning signal, or receiving a first signaling for triggering the first node to receive the sidelink positioning signal; or
receives information of resources, indicated by the higher layer or other nodes, for the first node to receive the sidelink positioning signal.

11. The method of claim 10, wherein at least one of the specific signal or the channel includes at least one of: a downlink synchronization signal, a physical downlink control channel (PDCCH), a physical downlink shared channel (PDSCH), a sidelink synchronization signal, a physical sidelink control channel (PSCCH), a physical sidelink shared channel (PSSCH), a physical sidelink feedback channel (PSFCH), or a positioning signal transmitted by other nodes, and
wherein in the case that the first node receives the first signaling for triggering the first node to receive the sidelink positioning signal, the sidelink positioning signal is received through the sidelink in the case that the first node further satisfies at least one of the following conditions:
the node transmitting the first signaling is a base station or a LMF;
the identity of the node transmitting the first signaling satisfies the preset conditions;
the geographical location indicated by the first signaling or the geographical location of the node transmitting the first signaling satisfies the preset conditions;
the range of parameters corresponding to the first signaling satisfies a third threshold range;
the range of parameters corresponding to the node transmitting the first signaling satisfies a fourth threshold range;
the node transmitting the first signaling has established a connection with the first node or communicated with the first node;
the node transmitting the first signaling has the capability to assist other nodes in positioning is indicated in the first signaling;
the identity of the first node is indicated in the first signaling; or
a condition for receiving the sidelink positioning signal is indicated in the first signaling, and the first node satisfies the indicated condition.

12. The method of claim 8, wherein determining the resources for receiving the sidelink positioning signal comprises: obtaining resources which are scheduled or configured by other nodes,
wherein at least one of the following is obtained from a higher layer or the other nodes in case of obtaining the resources which are scheduled or configured by other nodes:
information of a resource pool for receiving the sidelink positioning signal;
information of a resource set for receiving the sidelink positioning signal; or
information of resources for receiving the sidelink positioning signal, wherein determining the resources for receiving the sidelink positioning signal further comprises at least one of:
determining at least one of resources or the resource set for receiving the sidelink positioning signal in the resource pool based on at least one of specific parameters or configurations;
determining at least one of resources or the resource set for receiving the sidelink positioning signal in the resource pool based on the channel monitoring result;
determining resources for receiving the sidelink positioning signal in the resource set based on at least one of specific parameters or configurations; or
determining resources for receiving the sidelink positioning signal in the resource set based on the channel monitoring result.

13. The method of claim 8, further comprising at least one of:
determining, based on the measurement result, position information for at least one of the first node or a third node, wherein the third node is the node that transmits the sidelink positioning signal; or
feeding back the measurement result to other nodes, the measurement result is used to determine the position information.

14. A node comprising:
a transceiver; and
a processor coupled to the transceiver and configured to determine resources for transmitting a sidelink positioning signal; and
transmit the sidelink positioning signal on the determined resources.

15. A node comprising:
a transceiver; and
a processor coupled to the transceiver and configured to
determine resources for receiving a sidelink positioning signal;
receive the sidelink positioning signal on the determined resources; and
measure the sidelink positioning signal.
